(19) United States
(12) Patent Application Publication
(10) Pub. No.: US 2006/0020856 A1
(43) Pub. Date: Jan. 26, 2006

(54) Computer diagnostic interface

(76) Inventors: Tony O. Anuez, Houston, TX (US); Eric Owhadi, Tomball, TX (US)

Correspondence Address: HEWLETT-PACKARD COMPANY;Intellectual Property Administration, P. O. Box 272400, Fort Collins, CO, 80527-2400, US

(21) Appl. No.: 10/895,960

(22) Filed: Jul. 22, 2004

(51) Int. Cl. G06F 11/00

(52) U.S. Cl. 714/25

(57) ABSTRACT

According to one aspect of the present invention, there is provided a method for providing diagnostic indications representing detected failure conditions in a computer system, comprising: generating at least one indicator light waveform to present a predetermined quantity of one or more sequential illuminations of at least one indicator light; and, generating, at approximately the same time and in synchronicity with the at least one indicator light waveform, a corresponding at least one speaker audio waveform presenting, via a speaker, a same quantity of one or more sequential audible enunciations.

### BACKGROUND

Computers are being used in an increasing number of applications. While improvements are continually being made to make them usable by a wider cross-section of the population, the internal complexity of computer systems have also greatly increased so that today most users are unfamiliar with the internal design and configuration of the computers they use. As a consequence, when a computer fails to operate in the manner expected, a user is often unable to determine the source of the problem or how to resolve it.

Various approaches have been provided to enable a user to try to resolve problems they counter. For example, diagnostic programs, help files and manuals are often supplied by a computer manufacturer for such purposes. In addition, current computers are typically equipped with some form of internal diagnostics, the purpose of which is to detect and isolate component faults within the computer system.

However, much of the information contained within the diagnostic programs and manuals is often beyond the understanding of the average user. When faced with a problem, a user often must call the computer manufacturer's customer service line or help desk in order to obtain technical help, or may call on a technician or support personnel to service the computer. Such processes are often inefficient and unsatisfactory.

### SUMMARY

According to one aspect of the present invention, there is provided a method for providing diagnostic indications representing detected failure conditions in a computer system, comprising: generating at least one indicator light waveform to present a predetermined quantity of one or more sequential illuminations of at least one indicator light; and, generating, at approximately the same time and in approximate synchronicity with the at least one indicator light waveform, a corresponding at least one speaker audio waveform presenting, via a speaker, a same quantity of one or more sequential audible enunciations.

According to another aspect of the invention, there is provided a system for providing diagnostic indications representing detected failure conditions in a computer system, comprising: means for generating at least one indicator light waveform to present a predetermined quantity of one or more sequential illuminations of at least one indicator light; and means for generating, at approximately the same time and in approximate synchronicity with the at least one sequential indicator light waveform, a corresponding at least one speaker audio waveform to present, via a speaker, a same quantity of one or more sequential audible enunciations.

According to a further aspect of the invention, there is provided a computer system comprising: at least one indicator light located in a readily visible location on the computer system; at least one speaker; and an apparatus for providing diagnostic indications representing failure conditions detected in the computer system, wherein the apparatus is configured to generate at least one an indicator light waveform to present a predetermined quantity of one or more sequential illuminations of the at least one indicator light; and to generate, at approximately the same time and in synchronicity with the at least one sequential indicator light waveform, a corresponding at least one speaker audio waveform to present, via the at least one speaker, a same quantity of one or more sequential audible enunciations.

### BRIEF DESCRIPTION OF THE DRAWINGS

FIG. 1 is a diagram of exemplary indicator light and speaker audio waveforms in accordance with one embodiment of the present invention.

FIG. 2 is a table of diagnostic failure indications in accordance with one exemplary implementation of the present invention.

FIG. 3 is a block diagram of relevant components of an exemplary computer system implementing one embodiment of the present invention.

FIGS. 4A and 4B are a flow chart of the operations performed in accordance with one embodiment of the present invention.

FIG. 5 is a flow chart of the operations performed in accordance with one embodiment of the present invention.

### DETAILED DESCRIPTION

Embodiments of the present invention are directed to a diagnostic indication which provides information to a user or service technician regarding detected failure conditions in a computer system by providing sequential and synchronous illuminations (“blinks”) and audible enunciations (“beeps”) via a readily visible indicator light and speaker, respectively. Such sequential and synchronous diagnostic indications are indicative of associated predefined failure conditions which can include, but are not limited to, potential or actual failures, error conditions, faults, etc. Embodiments of the present invention can be implemented at any time prior to and/or during normal or diagnostic operations of a computer system. For example, some embodiments provide diagnostic indications prior to and/or during boot operations, including power-on-self-test (POST) operations. Such embodiments increase troubleshooting efficiency in circumstances in which the computer's processor and video are not yet operational (commonly referred to as “no boot-no video”).

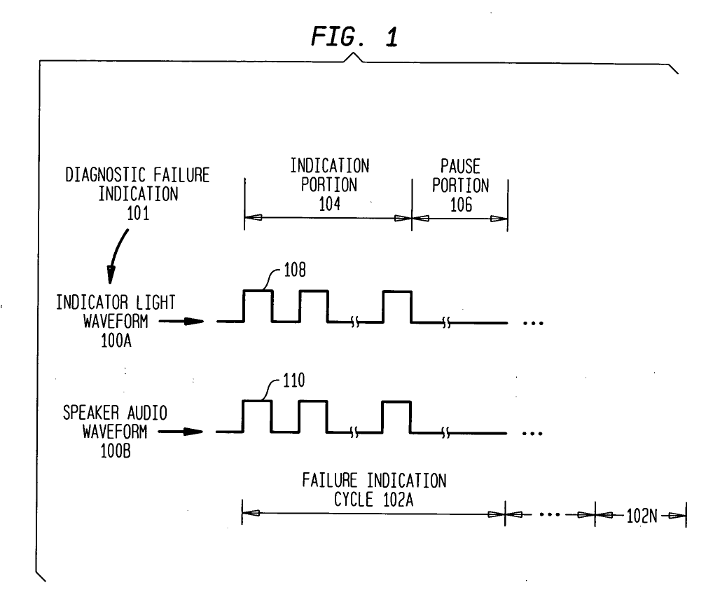

FIG. 1 is a diagram of an exemplary indicator light waveform 100A and an exemplary speaker audio waveform 100B, in accordance with one embodiment of the present invention. Together, these waveforms comprise a diagnostic failure indication 101. Each diagnostic indication waveform 100 comprises one or more indication cycles 102A-102N during each of which a diagnostic indication is presented. Each failure indication cycle 102 of each diagnostic indication waveform 100 comprises an indication portion 104 and a pause portion 106.

Indication portion 104 of indicator light waveform 100A comprises one or more illuminations (“blinks”) 108 of a predetermined frequency, while during a pause portion 106 of zero or more seconds no indicator light illuminations are presented. Similarly, indication portion 104 of speaker audio waveform 100B comprises one or more enunciations (“beeps”) 110 of a predetermined frequency, while during a pause portion 106 of zero or more seconds no speaker audio enunciations are presented. As shown in FIG. 1, indicator light waveform 100A and speaker audio waveform 100B begin at the same time. In addition, the quantity and frequency of pulses 108, 110 of waveforms 100A, 100B, as well as the duration of pause portion 106 of each waveform 100A, 100B, is the same. As such, diagnostic failure indication 101 comprises the presentation of sequential and synchronous audio and visual indications.

In one embodiment described below, diagnostic failure conditions are distinguished by the quantity of blinks/beeps in indication portions 104 of waveforms 100A, 100B. However, it should be appreciated that diagnostic failure conditions can be distinguished by any one or more of the above waveform characteristics including, but not limited to, frequency of blinks/beeps, the tone (pitch) of beeps 110 and the color or intensity of blinks 108, as discussed below. Such embodiments may be provided to further distinguish one failure condition from another, or to provide an increase in the number of diagnostic failure indications 101. It should also be appreciated that the duration of pause portion 106 of waveforms 100; that is, the time delay between each series of one or more beeps/blinks, may vary depending on the desired separation between successive indication portions 104 of multiple failure indication cycles 102 to insure, for example, that the failure indication is easily recognized.

Beeps 110 may be presented via a chassis speaker or on-board piezo speaker in the implementing computer system. Blinks 108 may be presented via an indicator light which is readily visible from a user's position relative to the computer under normal, non-diagnostic operating conditions. Indicator lights in such locations are easily viewed by a user or a service technician without having to interrupt the normal operations of the computer system. Such locations are generally and collectively referred to herein as readily visible locations. Also, such indicator lights may be dedicated or multiplexed indicator lights. According to certain embodiments of the present invention, such indicator lights are LEDs located on the front bezel of the computer system. Suitable existing front bezel LEDs include, but are not limited to, the power LED, hard drive LED, floppy disk drive LED, CD-ROM LED, DVD-ROM LED, CD-RW LED, etc. It should be appreciated that such LEDs are dedicated to operations other than diagnostic operations since diagnostic LEDs are typically located on the rear panel of the computer system. It should be appreciated, however, that in computer systems implementing diagnostic indicator lights in a location which is readily visible during normal operations, then those indicator lights can also be used in accordance with the teachings of the present invention. It should also be appreciated that dual-colored or tri-colored LEDs can be implemented in accordance with alternative embodiments of the present invention. For example, tri-colored LEDs can often be illuminated green, amber and red. In one exemplary embodiment, such colors can be used to indicate a diagnostic condition of a good (green), degraded (amber) and poor (red) health status.

Various embodiments of the present invention may be utilized on any computer system including, but not limited to, workstations, servers, desktop computers, blade systems, thin clients, laptops, hand-held computers, and other computer systems now or later developed (generally referred to herein as computer systems).

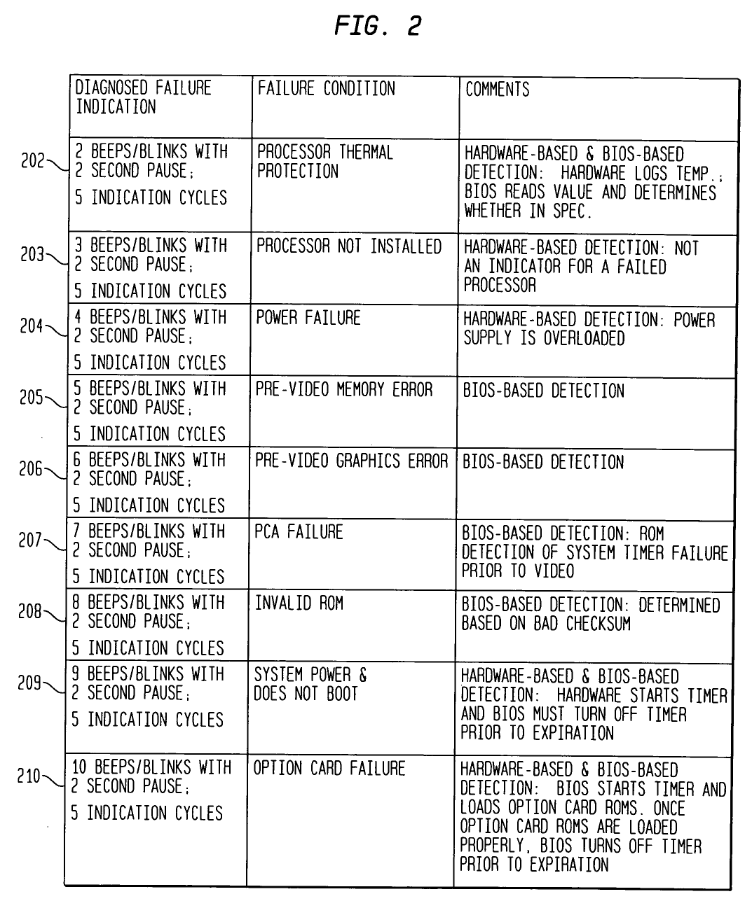

FIG. 2 is a table of one embodiment of the diagnostic failure indications 101. In this exemplary embodiment, repetition of a designated quantity of sequential and synchronous beeps 110 and blinks 108 are utilized to indicate a variety of predefined failure conditions. In this example, an on-board speaker and a front bezel LED are used to present beeps 10 and blinks 108, respectively. Also in this example, indication portion 104 of waveforms 100A, 100B comprises the quantity of 1 Hz blink/beeps indicated in FIG. 2, followed by a 2-second pause portion 106. A total of five (5) such failure indication cycles 102 are presented, as indicated in FIG. 2. As one of ordinary skill in the art would appreciate, however, indicator light waveform 100A and speaker audio waveform 100B can have other characteristics, as noted elsewhere herein.

As noted, diagnostic failure indications 101 can be presented to indicate failure conditions that occur prior to or during normal or diagnostic operations of the implementing computer system. In the example shown in FIG. 2, hardware-based detection, BIOS-based detection, or a combination of both techniques are represented. It should be appreciated by those of ordinary skill in the art that failure conditions detected via other techniques, such as software-based component self-test operations, can be represented in accordance with the teachings of the present invention.

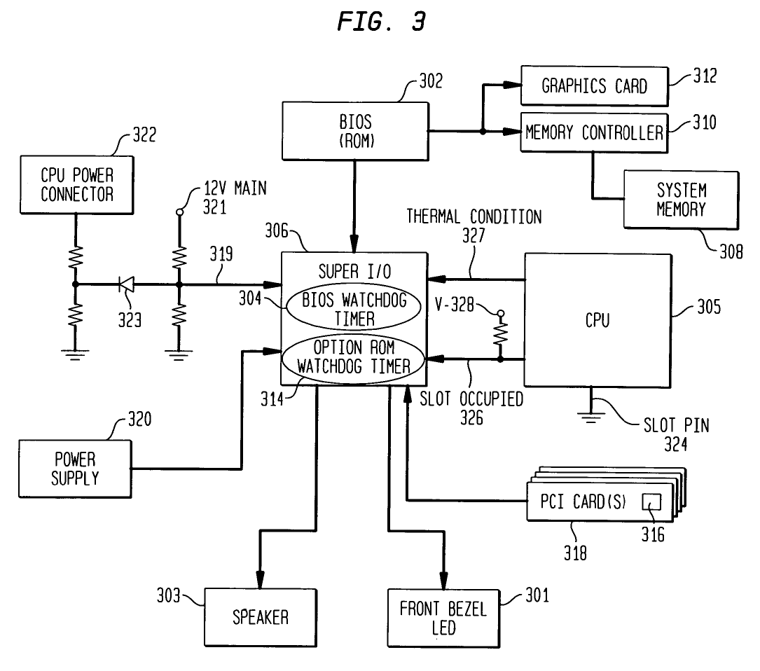

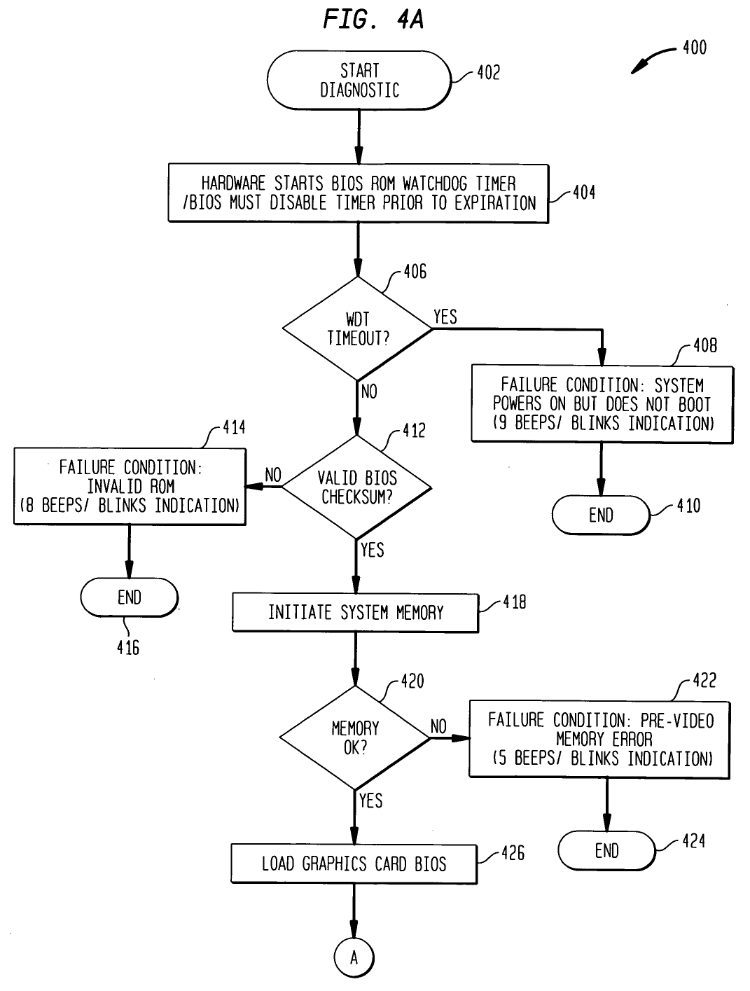

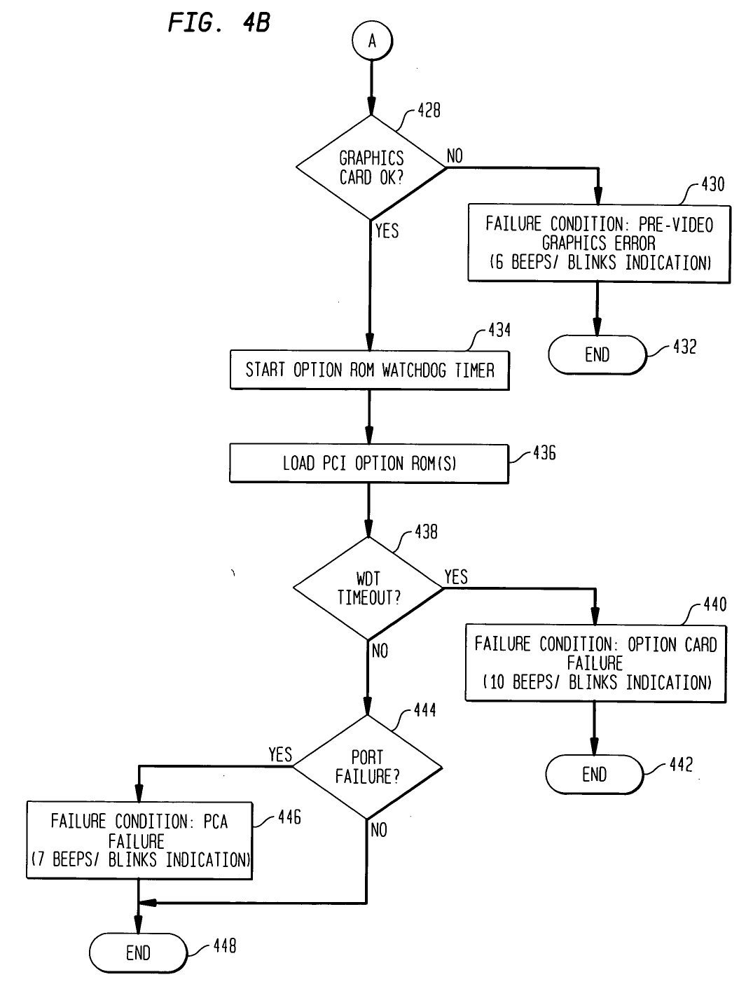

The diagnostic failure conditions 101 presented in FIG. 2 will now be described in the context of a particular implementation. FIG. 3 is a block diagram of relevant components of an exemplary computer system 300 in which embodiments of the present invention are implemented. FIGS. 4A and 4B are a flow chart of the operations performed in one embodiment of the present invention to implement the exemplary diagnostic strategy shown in FIG. 2 in the computer system shown in FIG. 3.

At block 402 (FIG. 4), diagnostic indication process 400 begins immediately upon receipt of power. To determine whether BIOS 302 (FIG. 3) has properly loaded, a watchdog timer 304 in super I/O 306 is started at block 404. In one embodiment, watchdog timer 304 is a one (1) second timer, although other timer durations can be implemented. BIOS 302 is configured to disable watchdog timer 304 once it has successfully started to fetch code. Should it fail to do so, then at block 408 failure indication 209 is generated by super I/O 306. As noted in FIG. 2, failure indication 209 indicates that the system powers on but failed to boot. As shown in FIG. 2, in this exemplary embodiment, failure indication 209 includes an indication portion 106 comprising the synchronous generation of nine (9) sequential beeps 110 via speaker 303 (FIG. 3), and nine (9) sequential blinks 108 of a front bezel LED 301 (FIG. 3), followed by a two second pause portion 106, which is repeated for five (5) indication cycles 102. After the five (5) indication cycles, the beeps 110 will cease; however, in one embodiment, the blinks 108 will continue to flash indefinitely until the system is power-cycled. Thereafter, process 400 ceases at block 410.

If watchdog timer 304 does not timeout at block 406, then process 400 continues at block 412. As part of the BIOS boot process, a checksum is validated. If BIOS 302 detects an invalid checksum at block 412, then process 400 continues at block 414. At block 414, failure condition 208 is generated by super I/O 306. As noted in FIG. 2, failure indication 208 indicates that BIOS 302 is invalid. As shown in FIG. 2, in this exemplary embodiment, failure indication 208 includes an indication portion 104 comprising the synchronous generation of eight (8) sequential beeps 110 via speaker 303, and eight (8) sequential blinks 108 of front bezel LED 301, followed by a two (2) second pause portion 106, which is repeated for five (5) indication cycles 102. After the five (5) indication cycles, the beeps 110 will cease; however, the blinks 108 will continue to flash indefinitely until the system is power-cycled. Thereafter, process 400 ceases at block 416. As one of ordinary skill in the art would appreciate, BIOS checksum validation is commonly performed during a BIOS upgrade process. If the checksum is determined to be invalid at that time, then the operations at block 414 will be performed, as noted above. It should also be appreciated that failure indication 208 may be presented to indicate other invalid ROM conditions.

If at block 412, BIOS 302 is determined to be valid, then process 400 continues at block 418. At block 418 system memory 308 (FIG. 3) is initiated via memory controller 310 (FIG. 3). If memory controller 310 fails to respond, or if the memory devices 308 fail to initiate or are defective, or if the memory devices 308 are improperly seated or missing, as determined at block 420, then at block 422 failure indication 205 is generated by super I/O 306. Referring to FIG. 2, failure indication 205 is generated to indicate that a pre-video memory error failure condition has occurred. In this exemplary embodiment, failure indication 205 includes an indication portion 104 comprising the synchronous generation of five (5) sequential beeps 110 via speaker 303, and five (5) sequential blinks 108 of front bezel LED 301, followed by a two (2) second pause portion 106. This failure indication cycle 102 is repeated for five (5) cycles. After the five (5) indication cycles, the beeps 110 will cease; however, in one embodiment, the blinks 108 will continue to flash indefinitely until the system is power-cycled. Thereafter, process 400 ceases at block 426.

If at block 420 it is determined that memory controller 310 and memory devices 308 are operational, then process 400 continues at block 426. At block 426, graphics BIOS is loaded in graphics card 312 (FIG. 3). If the graphics BIOS does not load properly, as determined at block 428 (FIG. 4B), then at block 430 failure condition 206 (FIG. 2) is generated by super I/O 306. As noted in FIG. 2, this failure indication is generated to indicate that a pre-video graphics error has occurred. In this exemplary embodiment, failure indication 206 includes an indication portion 104 comprising the synchronous generation of six (6) sequential beeps 110 via speaker 303, and six (6) sequential blinks 108 of front bezel LED 301, followed by a two second pause portion 106. This failure indication cycle 102 is also repeated for five (5) cycles. After the five (5) indication cycles, the beeps 110 will cease; however, in one embodiment, the blinks 108 will continue to flash indefinitely until the system is power-cycled. Thereafter, process 400 ceases at block 432.

If the graphics BIOS is determined to have loaded properly at block 428, then process 400 continue at block 434. At block 434, an option ROM watchdog timer 314 (FIG. 3) in super I/O 306 is started. At block 436, one or more PCI option ROMs 316 (FIG. 3) are loaded in their respective PCI card(s) 318. Option ROMs 316 are configured to notify BIOS 302 that they successfully loaded. BIOS 302 then disables watchdog timer 314. Should BIOS 302 fail to receive such notification and, in turn, fail to disable watchdog timer 314, then watchdog timer 314 will time out, as indicated at block 438. When this occurs, process 400 continues at block 440 at which failure condition 210 is generated by super I/O 306.

As noted in FIG. 2, failure indication 210 is generated to indicate that an option card failure has occurred. In this exemplary embodiment, failure indication 210 includes an indication portion 104 comprising the synchronous generation of ten (10) sequential beeps 110 via speaker 303, and ten (10) sequential blinks 108 of front bezel LED 301, followed by a two second pause portion 106, which is repeated for five (5) indication cycles 102. After the five (5) indication cycles, the beeps 110 will cease; however, in one embodiment, the blinks 108 will continue to flash indefinitely until the system is power-cycled. Thereafter, process 400 ceases at block 442. As one of ordinary skill in the art would find apparent, such a failure condition may be detected at any time during normal operations of computer system 300.

If PCI option ROMs 316 load(s) properly and watchdog timer 314 does not timeout at block 438, then process 400 continues at block 444. At block 444, any port failures other than memory controller 310, memory devices 308, graphics card 312 and PCI card(s) 318 is detected. If a port failure is detected, then process 400 continues at block 446 at which failure condition 207 is generated by super I/O 306. It should be appreciated by those of ordinary skill in the art that ports are often checked throughout POST, and are not performed only at this part of process 400. Accordingly, in alternative embodiments, the operations at block 444 and 446 are performed multiple times throughout the POST process.

As noted in FIG. 2, failure indication 207 is generated to indicate a PCA failure has occurred. In this exemplary embodiment, failure indication 207 includes an indication portion 104 comprising the synchronous generation of seven (7) sequential beeps 110 via speaker 303, and seven (7) sequential blinks 108 of front bezel LED 301, followed by a two second pause portion 106, which is repeated for five (5) indication cycles 102. After the five (5) indication cycles, the beeps 110 will cease; however, in one embodiment, the blinks 108 will continue to flash indefinitely until the system is power-cycled. Thereafter, process 400 ceases at block 448.

If no port failure is detected at block 444, process 400 ends at block 448. In one embodiment, the above operations of process 400 are performed during the loading of BIOS 302 and during subsequent POST operations. It should be appreciated that not all of the above operations need to be performed in a given embodiment, and that they need not be performed in the sequence presented above. Furthermore, as noted, diagnostic failure indications can also be presented for failure conditions detected in other ways. In FIG. 2, for example, there are also any number of hardware-detected failure conditions for which diagnostic failure indications may be generated.

In the example provided in FIG. 2, these include, for example, a failure indication 204 which is generated by super I/O 306 to indicate a power failure. A power failure may occur, for example, by power supply 320 entering a protected mode of operation, or when the CPU power harness is determined to not have been properly connected to the CPU power connector 322. In the embodiment shown in FIG. 3, power line 319 is connected to a 12 volt source 321. CPU connector 322 is connected to power line 319 via a diode 323. In operation, when CPU connector 322 is not plugged in, the 12 volt monitor level will fall below a predetermined threshold value. This will be detected by super I/O 306 which will then generate failure condition 204. As shown in FIG. 2, in this exemplary embodiment, failure indication 204 includes an indication portion 104 comprising the synchronous generation of four (4) sequential beeps 110 via speaker 303, and four (4) sequential blinks 108 of front bezel LED 301, followed by a two second pause portion 106, which is repeated for five (5) indication cycles 102. After the five (5) indication cycles, the beeps 110 will cease; however, in one embodiment, the blinks 108 will continue to flash indefinitely until the system is power-cycled.

Another failure condition which may be represented by diagnostic failure indications 101 is the hardware-based detection of CPU 305 exceeding a predetermined threshold temperature. When such a condition is detected, super I/O 306 will shut down computer system 300 and generate failure indication 202. As shown in FIG. 2, in this exemplary embodiment, failure indication 202 includes an indication portion 104 comprising the synchronous generation of two (2) sequential beeps 10 via speaker 303, and two (2) sequential blinks 108 of front bezel LED 301, followed by a two second pause portion 106, which is repeated for five (5) indication cycles 102. After the five (5) indication cycles, the beeps 110 will cease; however, in one embodiment, the blinks 108 will continue to flash indefinitely until the system is power-cycled.

Another failure condition which may be represented by diagnostic failure indications 101 is the hardware-based detection of the absence of CPU 305. If processor 305 is not installed, slot pin 324 will be pulled to a high voltage due to slot-occupied line 326 being connected to a backup power source 328. When slot pin 324 is high, super I/O 306 will generate failure indication 203. On the other hand, when CPU 305 is installed, slot pin 324 is connected to ground and no failure indication is generated. As shown in FIG. 2, in this exemplary embodiment, failure indication 203 includes an indication portion 104 comprising the synchronous generation of three (3) sequential beeps 110 via speaker 303, and three (3) sequential blinks 108 of front bezel LED 301, followed by a two second pause portion 106, which is repeated for five (5) indication cycles 102. After the five (5) indication cycles, the beeps 110 will cease; however, in one embodiment, the blinks 108 will continue to flash indefinitely until the system is power-cycled.

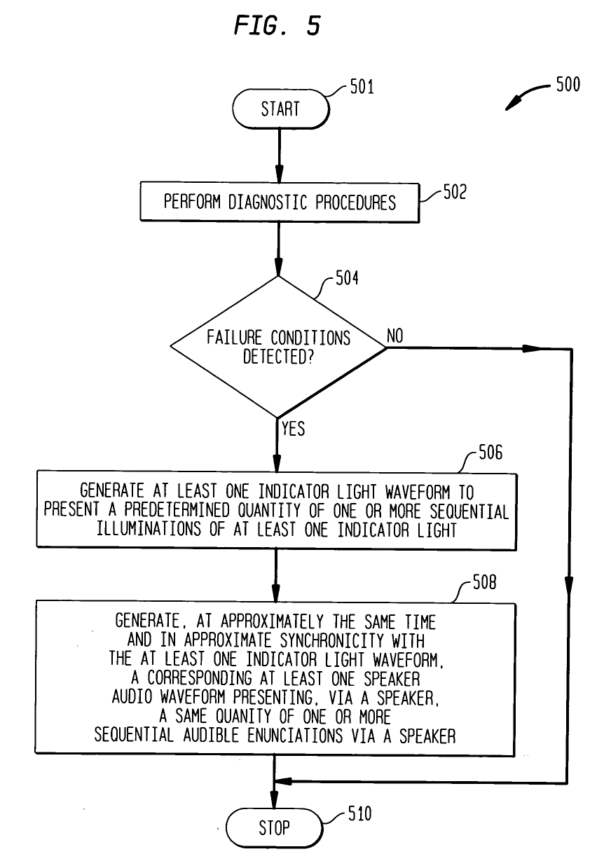

FIG. 5 is a high-level flow chart of the operations performed in accordance with one embodiment of the present invention. At block 502, the diagnostic process 500 begins. At block 502, one or more diagnostic procedures are performed. At block 504, a determination is made regarding whether a failure condition has been detected. If not, process 500 ends. Otherwise, at block 506, at least one indicator light waveform is generated to present a predetermined quantity of one or more sequential illuminations of at least one indicator light. At block 508, at approximately the same time and in approximate synchronicity with the at least one indicator light waveform, a corresponding at least one speaker audio waveform is generated to present, via a speaker, a same quantity of one or more sequential audible enunciations via a speaker. Processing then ends at block 510.

It should be appreciated that the teachings of the present invention can be used in conjunction with other diagnostic techniques. For example, after a predetermined number of indication cycles 102 of diagnostic indications 101, either or both of beeps 110 and blinks 108 may cease, leaving the other to continue. It should also be appreciated that in alternative embodiments various combinations of two or more indicator lights may be used in conjunction with various audible signals to expand the number of failure conditions that may be presented. It should further be appreciated that in alternative embodiments the audible signals may be emitted at different frequencies to increase the distinction between the various signals and to provide easier recognition and decoding over a telephone or related means.

What is claimed is:

1. A method for providing diagnostic indications representing detected failure conditions in a computer system, comprising:
generating at least one indicator light waveform to present a predetermined quantity of one or more sequential illuminations of at least one indicator light; and
generating, at approximately the same time and in approximate synchronicity with the at least one indicator light waveform, a corresponding at least one speaker audio waveform presenting, via a speaker, a same quantity of one or more sequential audible enunciations via a speaker.

2. The method of claim 1, wherein generating the at least one indicator light waveform comprises:
generating at least one indication cycle comprising a first indication portion during which the quantity of one or more sequential illuminations is presented, and a first pause portion during which no illuminations are presented.

3. The method of claim 2, wherein generating the at least one speaker audio waveform comprises:
generating at least one indication cycle comprising a second indication portion during which the quantity of one or more sequential audible enunciations are presented, and a second pause portion during which no enunciations are presented.

4. The method of claim 1,
wherein generating at least one indicator light waveform comprises generating a plurality of indicator light waveforms each comprising a quantity of one or more sequential illuminations that uniquely represent an associated failure condition, and
wherein generating at least one speaker audio waveform comprises generating a plurality of speaker audio waveforms each comprising a same quantity of sequential audible enunciations to uniquely represent a same associated failure condition.

5. The method of claim 1, wherein diagnostic failure conditions can be distinguished by one or more of the following waveform characteristics:
quantity of sequential indicator light illuminations and audible enunciations;
frequency of sequential indicator light illuminations and audible enunciations;
pitch of one or more of the sequential audible enunciations; and
color of one or more of the sequential indicator light illuminations.

6. The method of claim 1, wherein the at least one indicator light is located at a readily visible location on the computer system.

7. The method of claim 1, wherein the readily visible location on the computer system comprises:
a front bezel of the computer system.

8. The method of claim 1, wherein the at least one indicator light comprises one or more of the group consisting of:
at least one dual-colored light emitting diode (LED); and
at least one tri-colored LED.

9. The method of claim 1, wherein the at least one indicator light comprises one or more of the group consisting of:
a power LED;
a hard drive LED;
a floppy disk drive LED;
a CD-ROM LED;
a DVD-ROM LED; and
a CD-RW LED.

10. The method of claim 1, wherein the speaker comprises at least one of the group consisting of:
a chassis speaker; and
one or more on-board speakers.

11. The method of claim 1, wherein the detected failure conditions comprise one or more of the group consisting of:
potential failures;
actual failures;
error conditions; and
faults.

12. The method of claim 1, wherein the detected failure conditions comprise failure conditions detected during one or more of the detection operations consisting of:
BIOS-based failure detection operations; and
hardware-based detection operations.

13. The method of claim 1, wherein the detected failure conditions comprise one or more of the group consisting of:
a condition in which system BIOS fails to properly fetch code and execute;
a condition in which system BIOS is corrupted;
a condition in which a memory of the computer system fails;
a condition in which a graphics BIOS fails to successfully load in a graphics card of the computer system;
a condition in which an option ROM fails to successfully load in its respective PCI card of computer system;
a condition in which an option card failure is detected;
a condition in which a port failure is detected;
a condition in which a power failure is detected;
a condition in which a processor of the computer system exceed a predetermined threshold temperature; and
a condition in which absence of a processor of the computer system is detected.

14. A system for providing diagnostic indications representing detected failure conditions in a computer system, comprising:
means for generating at least one indicator light waveform to present a predetermined quantity of one or more sequential illuminations of at least one indicator light; and
means for generating, at approximately the same time and in approximate synchronicity with the at least one sequential indicator light waveform, a corresponding at least one speaker audio waveform to present, via a speaker, a same quantity of one or more sequential audible enunciations.

15. The system of claim 14, wherein the means for generating the at least one indicator light waveform comprises:
means for generating at least one indication cycle comprising a first indication portion during which the quantity of one or more sequential illuminations is presented, and a first pause portion during which no illuminations are presented.

16. The system of claim 15, wherein the means for generating the at least one speaker audio waveform comprises:
means for generating at least one indication cycle comprising a second indication portion during which the quantity of one or more sequential audible enunciations are presented, and a second pause portion during which no enunciations are presented.

17. The system of claim 14,
wherein the means for generating at least one indicator light waveform comprises means for generating a plurality of indicator light waveforms each comprising a quantity of one or more sequential illuminations that uniquely represent an associated failure condition, and
wherein the means for generating at least one speaker audio waveform comprises means for generating a plurality of speaker audio waveforms each comprising a same quantity of sequential audible enunciations to uniquely represent a same associated failure condition.

18. The system of claim 14, wherein diagnostic failure conditions can be distinguished by one or more of the following waveform characteristics:
quantity of sequential indicator light illuminations and audible enunciations;
frequency of sequential indicator light illuminations and audible enunciations;
pitch of one or more of the sequential audible enunciations; and
color of one or more of the sequential indicator light illuminations.

19. The system of claim 14, wherein the at least one indicator light is located at a readily visible location on the computer system.

20. The system of claim 14, wherein the speaker comprises at least one of the group consisting of:
a chassis speaker; and
one or more on-board speakers.

21. The system of claim 14, wherein the detected failure conditions comprise failure conditions detected during one or more of the detection operations consisting of:
BIOS-based failure detection operations; and
hardware-based detection operations.

22. A computer system comprising:
at least one indicator light located in a readily visible location on the computer system;
at least one speaker; and
an apparatus for providing diagnostic indications representing failure conditions detected in the computer system, wherein the apparatus generates at least one an indicator light waveform to present a predetermined quantity of one or more sequential illuminations of the at least one indicator light; and which generates, at approximately the same time and in synchronicity with the at least one sequential indicator light waveform, a corresponding at least one speaker audio waveform to present a same quantity of one or more sequential audible enunciations via the at least one speaker.

23. The computer of claim 22, wherein each of the at least one indicator light waveform and the at least one speaker audio waveform comprise:
at least one indication cycle comprising a indication portion during which the quantity of one or more sequential illuminations and enunciations is presented, and a pause portion during which no illuminations and enunciations are presented.

24. The computer of claim 22,
wherein generating at least one indicator light waveform comprises generating a plurality of indicator light waveforms each comprising a quantity of one or more sequential illuminations that uniquely represents an associated failure condition, and
wherein generating at least one speaker audio waveform comprises generating a plurality of speaker audio waveforms each comprising a same quantity of sequential audible enunciations to uniquely represents a same associated failure condition.

25. The computer of claim 22, wherein the at least one indicator light is located at a readily visible location on the computer system.

26. The computer of claim 1, wherein the speaker comprises at least one of the group consisting of:
a chassis speaker; and
one or more on-board speakers.

27. The computer of claim 22, wherein the detected failure conditions comprise failure conditions detected during one or more of the group consisting of:
BIOS-based detection failure operations; and
hardware-based detection failure operations.
